(19) United States
(12) Patent Application Publication
(10) Pub. No.: US 2015/0260562 A1
(43) Pub. Date: Sep. 17, 2015

(54) WIRELESS LIQUID METERING DEVICE

(71) Applicant: Andrew Dawn, Roseville, CA (US)

(72) Inventor: Andrew Dawn, Roseville, CA (US)

(21) Appl. No.: 14/659,428

(22) Filed: Mar. 16, 2015

Related U.S. Application Data
(60) Provisional application No. 61/953,558, filed on Mar. 14, 2014.

(51) Int. Cl. G01F 15/06; G01F 1/05

(52) U.S. Cl. CPC G01F 15/063; G01F 1/05

(57) ABSTRACT

A device for measuring the usage of a liquid, according to one embodiment, includes a first opening for receiving a liquid, a rotating portion positioned to rotate as a liquid passes through the first opening, a generator mechanically paired to the rotating portion, a power bank electrically coupled to the generator, an encoder for generating an indication of rotation of the rotating portion, a wireless transmitter, a circuit configured to generate information based on a rotation of the rotating portion and transmit the information using the wireless transmitter, a second opening for allowing the liquid to pass from the device and a housing coupled to the rotating portion and circuit.

### RELATED APPLICATION

The present application claims benefit of U.S. Provisional Patent Application No. 61/953,558 filed Mar. 14, 2014, which is incorporated by reference.

### FIELD OF THE INVENTION

The present invention relates to liquid measurement, and more particularly, this invention relates to liquid measurement and liquid measurement analysis.

### BACKGROUND

A liquid source may over time be tapped at a less-conservative rate due to a user being unaware of the amount of a liquid they are utilizing and/or the dispense rate of the liquid they are drawing off of. This potentially wasteful behavior is especially concerning in terms of water, for example, which is becoming a commodity in need of conservation efforts. Attempting to ration a liquid may prove difficult without a gauge of some sort, and furthermore may prove inaccurate if the amount being used is unknown.

### SUMMARY

A device for measuring the usage of a liquid, according to one embodiment, includes a first opening for receiving a liquid, a rotating portion positioned to rotate as a liquid passes through the first opening, a generator mechanically paired to the rotating portion, a power bank electrically coupled to the generator, an encoder for generating an indication of rotation of the rotating portion, a wireless transmitter, a circuit configured to generate information based on a rotation of the rotating portion and transmit the information using the wireless transmitter, a second opening for allowing the liquid to pass from the device and a housing coupled to the rotating portion and circuit.

A method, according to another embodiment, includes determining a rotation count of a rotating portion of a liquid measuring device as a result of a liquid passing across the rotating portion, and outputting information based on the determined rotation count.

A method for processing data received from a liquid measuring device, according to yet another embodiment, includes receiving information derived from a rotation count of the liquid measuring device via wireless link, calculating data based on the information, and outputting the calculated data to a user display application.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a diagram of an architecture in accordance with one embodiment.

FIG. 2 is a diagram of a representative hardware environment associated with a user device in accordance with one embodiment.

FIG. 3 is a partial cross sectional perspective view of a device in accordance with one embodiment.

FIG. 4 is a flowchart of a method in accordance with one embodiment.

FIG. 5 is a flowchart of a method in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of processes for liquid measurement and liquid measurement analysis and/or related systems and methods. Embodiments described herein provide a device and method for metering the use of a liquid such as water, and wirelessly outputting metering data.

In one general embodiment, a device for measuring the usage of a liquid, includes a first opening for receiving a liquid, a rotating portion positioned to rotate as a liquid passes through the first opening, a generator mechanically paired to the rotating portion, a power bank electrically coupled to the generator, an encoder for generating an indication of rotation of the rotating portion, a wireless transmitter, a circuit configured to generate information based on a rotation of the rotating portion and transmit the information using the wireless transmitter, a second opening for allowing the liquid to pass from the device and a housing coupled to the rotating portion and circuit.

In another general embodiment, a method includes determining a rotation count of a rotating portion of a liquid measuring device as a result of a liquid passing across the rotating portion, and outputting information based on the determined rotation count.

In yet another general embodiment, a method for processing data received from a liquid measuring device includes receiving information derived from a rotation count of the liquid measuring device, calculating data based on the information, and outputting the calculated data to a user display application.

The description herein is presented to enable any person skilled in the art to make and use the invention and is provided in the context of particular applications of the invention and their requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In particular, various embodiments of the invention discussed herein are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links may be utilized.

The program environment in which one embodiment of the invention may be executed illustratively incorporates one or more general-purpose computers or special-purpose devices such hand-held computers. Details of such devices (e.g., processor, memory, data storage, input and output devices) are well known and are omitted for the sake of clarity.

It should also be understood that the techniques of the present invention might be implemented using a variety of technologies. For example, the methods described herein may be implemented in software running on a computer system, or implemented in hardware utilizing one or more processors and logic (hardware and/or software) for performing operations of the method, application specific integrated circuits, programmable logic devices such as Field Programmable Gate Arrays (FPGAs), and/or various combinations thereof. In one illustrative approach, methods described herein may be implemented by a series of computer-executable instructions residing on a storage medium such as a physical (e.g., non-transitory) computer-readable medium. In addition, although specific embodiments of the invention may employ object-oriented software programming concepts, the invention is not so limited and is easily adapted to employ other forms of directing the operation of a computer.

The invention can also be provided in the form of a computer program product comprising a computer readable storage or signal medium having computer code thereon, which may be executed by a computing device (e.g., a processor) and/or system. A computer readable storage medium can include any medium capable of storing computer code thereon for use by a computing device or system, including optical media such as read only and writeable CD and DVD, magnetic memory or medium (e.g., hard disk drive, tape), semiconductor memory (e.g., FLASH memory and other portable memory cards, etc.), firmware encoded in a chip, etc.

A computer readable signal medium is one that does not fit within the aforementioned storage medium class. For example, illustrative computer readable signal media communicate or otherwise transfer transitory signals within a system, between systems e.g., via a physical or virtual network, etc.

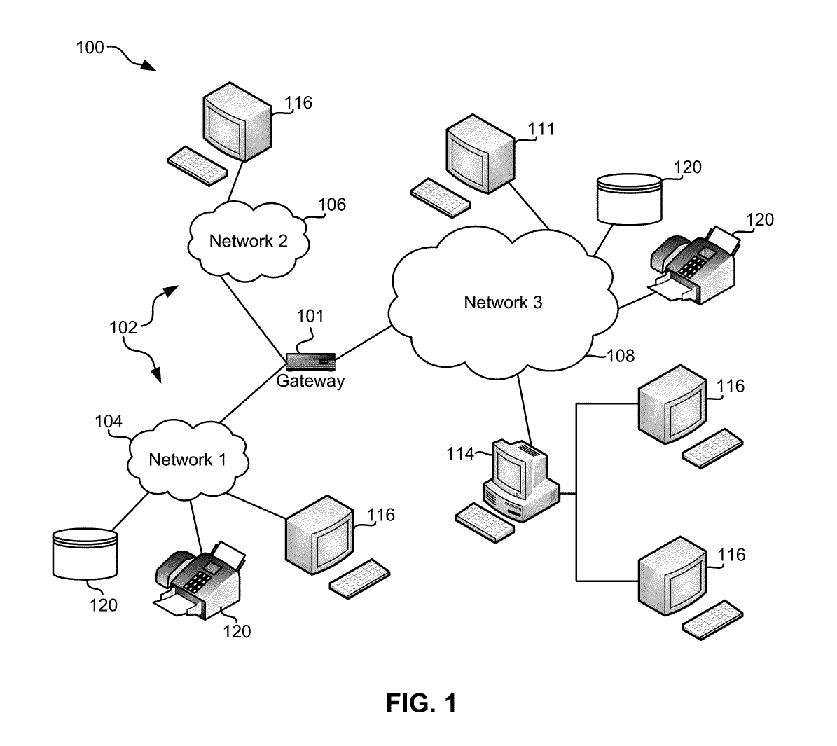

FIG. 1 illustrates an architecture 100, in accordance with one embodiment. As an option, the present architecture 100 may be implemented in conjunction with features from any other embodiment listed herein, such as those described with reference to the other FIGS. Of course, however, such architecture 100 and others presented herein may be used in various applications and/or in permutations which may or may not be specifically described in the illustrative embodiments listed herein. Further, the architecture 100 presented herein may be used in any desired environment.

As shown in FIG. 1, a plurality of remote networks 102 are provided including a first remote network 104 and a second remote network 106. A gateway 101 may be coupled between the remote networks 102 and a proximate network 108. In the context of the present network architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, laptop computer, hand-held computer, printer or any other type of logic. It should be noted that a user device 111 may also be directly coupled to any of the networks, in one embodiment.

A peripheral 120 or series of peripherals 120, e.g. facsimile machines, printers, networked storage units, etc., may be coupled to one or more of the networks 104, 106, 108. It should be noted that databases, servers, and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates a MAC OS environment, a UNIX system which virtually hosts a MICROSOFT WINDOWS environment, a MICROSOFT WINDOWS system which emulates a MAC OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data processing and/or storage, servers, etc., are provided to any system in the cloud, preferably in an on-demand relationship, thereby allowing access and distribution of services across many computing systems. Cloud computing typically involves an Internet or other high speed connection (e.g., 4G LTE, fiber optic, etc.) between the systems operating in the cloud, but other techniques of connecting the systems may also be used.

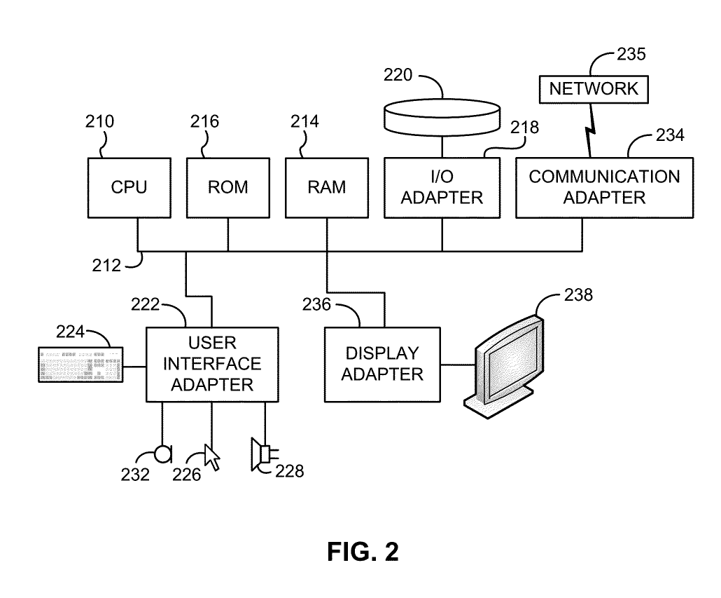

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft WINDOWS Operating System (OS), a MAC OS, a UNIX OS, etc. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

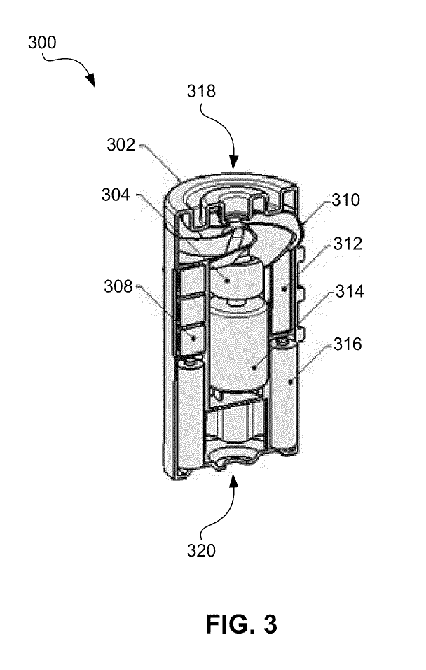

FIG. 3 depicts a device 300 for measuring the usage of a liquid, in accordance with one embodiment. As an option, the present device 300 may be implemented in conjunction with features from any other embodiment listed herein, such as those described with reference to the other FIGS. Of course, however, such device 300 and others presented herein may be used in various applications and/or in permutations which may or may not be specifically described in the illustrative embodiments listed herein. Further, the device 300 presented herein may be used in any desired environment.

Device 300 includes a first opening 318 for receiving a liquid. The first opening 318 may be configured to accept and/or pair with interchangeable adapters for coupling the device 300 to a variety of liquid sources. For example, device 300 may include a threaded portion for coupling device 300 to a liquid source, e.g., of a faucet, of a shower head, of a hose bib, of a liquid fixture, etc.

Device 300 additionally includes a rotating portion 310 positioned to rotate as a liquid passes through the first opening 318. The rotating portion 310 may include an impeller, e.g., a rotor, an axial rotating propeller, etc.; a water wheel; a turbine; etc.

A generator 314 is mechanically paired to the rotating portion 310. The pairing between the generator 314 and the rotating portion 310 may be established, e.g., by an axial driveshaft, by a gear mechanism, by a mechanical pairing of a type known in the art, etc. The generator 314 may be configured to generate electricity in response to the rotating portion 310 (which the generator 314 is mechanically paired to) rotating, and thereby driving the generator, as a liquid passes through the first opening 318.

Device 300 may also include drive magnets and magnetic couplings 304.

Device 300 further includes a power bank 316 electrically coupled to the generator 314. The power bank 316 may include, e.g., a rechargeable battery, a capacitor, a power storage device of a type known in the art, etc., and/or an array of any of these. Generated electricity may be delivered to the power bank 316 as the electricity is generated and/or after the electricity is generated. The power bank 316 may store electricity generated by the generator. According to various embodiments, electricity stored in the power bank 316 may provide a power source for device 300 when the generator 314 is no longer generating electricity e.g. when a liquid is not passing through the first opening 318, etc. According to other embodiments, electricity stored in the power bank 316 may provide a power source for device 300 while the generator 314 is generating electricity (when a liquid is passing through the first opening 318) e.g. in response to a function of device 300 requiring more power than the generator 314 can provide while functioning, etc.

With continued reference to FIG. 3, device 300 includes an encoder for generating an indication of rotation of the rotating portion. As described herein, the rotating of the rotating portion may occur as a liquid passes through the first opening 318. Furthermore, the indication of rotation of the rotating portion may include a data recording, e.g., a count, electronic signals that indicate a partial or full rotation, mechanical triggers that indicate a partial or full rotation, etc. This indication of rotation of the rotating portion may be used to determine the amount of liquid passing across the impeller over a period of time as will be described herein.

Device 300 also includes a wireless transmitter 308. The wireless transmitter 308 may be used to output information generated in the circuitry of device 300 e.g. information that may be used to determine the amount of liquid passing across the impeller over a period of time, etc.

Device 300 additionally includes a circuit 312 configured to generate information based on a rotation, e.g., a rotation count, etc., of the rotating portion 310 and transmit the information using the wireless transmitter 308. The circuit may include a processor, a controller, etc.

Electricity, (e.g., electricity generated in response to the rotating portion 310 rotating, and thereby driving a generator, as a liquid passes through the first opening 318 and/or from the power bank 316), may be delivered to the circuit 312, e.g., to at least in part power the circuit 312, etc.

The circuit 312 may additionally be configured to select the power source used during outputting information from the device 300 using the wireless transmitter 308. For example, according to various embodiments, the circuit 312 may be configured to select active power, e.g., electricity generated by the rotating portion 310 (which the generator 314 is mechanically paired to) rotating as a liquid passes through the first opening 318, etc., during outputting from the device 300 using the wireless transmitter 308. According to other embodiments, the circuit 312 may be configured to select power stored in the power bank 316, during outputting from the device 300 using the wireless transmitter 308.

A second opening 320 allows the liquid to pass from the device 300. Similar to the first opening 318, the second opening 318 may be configured to accept and/or pair with interchangeable adapters for coupling the device 300 to a variety of additional devices. For example, the second opening 318 of device 300 may include a threaded portion for coupling device 300 to, e.g., a liquid purifier, a liquid stream multiplier, a device known in the art to be attached to a liquid source, etc.

Device 300 also includes a housing 302 coupled to the rotating portion 310 and circuit 312. The housing 302 may be configured to protect liquid sensitive components e.g. circuit 312, power bank 316, wireless transmitter 308 of device 300 from liquid damage. Furthermore, in embodiments where liquids with cool temperatures pass through device 300, the housing 302 may be configured to thermally cool e.g. by isolating the temperature differential of the liquid, etc., heat sensitive components, e.g., circuit 312, power bank 316, wireless transmitter 308, etc. of device 300.

It should be noted that although device has been described herein to be configured to accept and/or pair with interchangeable adapters for coupling the device 300 to a variety of liquid sources and/or additional devices, the housing of the device may alternatively be configured for installation within a liquid source dispensing device. For example, device 300 may be installed/embedded within and/or as a component of e.g. a kitchen faucet, a shower head, etc.

A preferred method of generating information, e.g., based on a rotation of the rotating portion 310 and outputting the information, e.g., using the wireless transmitter 308 will now be described below.

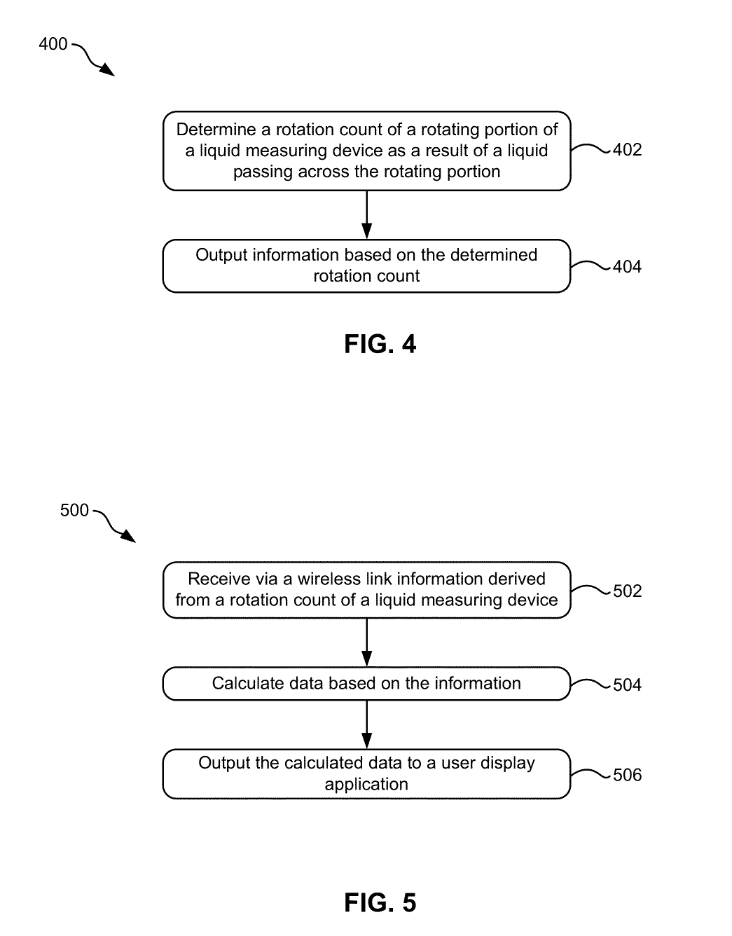

Now referring to FIG. 4, a flowchart of a method 400 is shown according to one embodiment. The method 400 may be performed in accordance with the present invention in any of the environments depicted in FIGS. 1-3, among others, in various embodiments. Of course, more or less operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by liquid measuring devices, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

In operation 402, a rotation count and/or derivative thereof (e.g., rotation speed, etc.) of a rotating portion, e.g., impeller, etc., of a liquid measuring device as a result of a liquid passing across the rotating portion is determined. In one example, a rotation count based on the number of times an impeller turns as the liquid passes across it may be determined, e.g., with an encoder, via a circuit, via a sensor detecting an optical marker or magnet that rotates with the impeller, etc.

In operation 404, information based on the determined rotation count is output. The information based on the determined rotation count may be output to one or various destinations using various outputting hardware, e.g., a wireless transmitter, a network interface for transmitting over a cable, etc. The destinations may include a cloud server, a computer, a liquid provider such as a water company, etc.

According to various embodiments, prior to outputting information, e.g., where the information includes the calculated amount of liquid, etc., the amount of liquid passing across the rotating portion may be calculated based on the determined rotation count. Accordingly, the output information may, according to one embodiment, include one or more of, e.g., the rotation count, the calculated amount of liquid, other information, etc.

In an alternative embodiment, the output information may include only the rotation count.

A method for processing data received from a liquid measuring device will now be detailed below.

Now referring to FIG. 5, a flowchart of a method 500 is shown according to one embodiment. The method 500 may be performed in accordance with the present invention in any of the environments depicted in FIGS. 1-3, among others, in various embodiments. Of course, more or less operations than those specifically described in FIG. 5 may be included in method 500, as would be understood by one of skill in the art upon reading the present descriptions.

Each of the steps of the method 500 may be performed by any suitable component of the operating environment. For example, in various embodiments, the method 500 may be partially or entirely performed by liquid measuring devices, or some other device having one or more processors therein. The processor, e.g., processing circuit(s), chip(s), and/or module(s) implemented in hardware and/or software, and preferably having at least one hardware component may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

In operation 502, information derived from a rotation count of the liquid measuring device is received at least in part via a wireless link such as WiFi, Bluetooth. Note that other legs of the link may be hardwired, such as via Ethernet cable, an internet connection, etc. According to various embodiments, the information derived from a rotation count may be received, e.g., for processing, etc. in a cloud computing service; in a computer in communication therewith via WiFi, Bluetooth, etc.; etc. In other embodiments, the information received may include and/or be the rotation count.

In operation 504, data is calculated based on the information. According to preferred embodiments, data calculated based on the information may include, e.g., the volume of liquid that passed through a liquid measuring device, the time a volume of liquid passed through a liquid measuring device, the volume of liquid per unit time that passed through a liquid measuring device, any type of statistical data derivable from the information using known techniques, etc.

In operation 506, the calculated data is output to a user display application. Outputting calculated data may provide a user with an accurate and rapid evaluation of liquid usage.

For example, a user may find it advantageous to use their tap faucet with a liquid metering device installed on and/or in the faucet, and e.g. due to the functioning of device 300 and processing of methods described herein, etc., rapidly assess e.g. the efficiency and/or conservation efficiency of their use. Such a rapid and incremental usage metering would not be possible to accurately gauge based on a monthly water bill for example.

According to various embodiments, the calculated data output to a user display application may include additional predefined information, e.g., previously calculated usage history, conservation tips, etc. Additional predefined information may further assist a user in evaluating his/her usage of a liquid.

Furthermore, in addition to and/or alternatively to the calculated data being output to a user display application, the calculated data may be output to a local water authority.

Similarly, in addition to and/or alternatively to the calculated data being output to a user display application, the calculated data may be output to a web based application.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A device for measuring the usage of a liquid, comprising:
a first opening for receiving a liquid;
a rotating portion positioned to rotate as a liquid passes through the first opening;
a generator mechanically paired to the rotating portion;
a power bank electrically coupled to the generator;
an encoder for generating an indication of rotation of the rotating portion;
a wireless transmitter;
a circuit configured to generate information based on a rotation of the rotating portion and transmit the information using the wireless transmitter;
a second opening for allowing the liquid to pass from the device; and
a housing coupled to the rotating portion and circuit.

2. The device of claim 1 comprising:
a threaded portion for coupling the device to a liquid source.

3. The device of claim 1, wherein;
the circuit is configured for selecting the power source used during outputting from the device using the wireless transmitter.

4. The device of claim 1, wherein;
the housing of the device is configured for installation within a liquid source dispensing device.

5. A method, comprising:
determining a rotation count of a rotating portion of a liquid measuring device as a result of a liquid passing across the rotating portion,
outputting information based on the determined rotation count.

6. The method of claim 5, comprising:
calculating the amount of liquid passing across the rotating portion prior to outputting information based on the determined impeller rotation count, wherein the information includes the calculated amount of liquid.

7. The method of claim 5, wherein the information includes the rotation count.

8. The method of claim 5, wherein the liquid passing across the rotating portion generates electricity.

9. The method of claim 8, comprising:
delivering the generated electricity to a power bank.

10. The method of claim 8 comprising:
delivering the generated electricity to a circuit, configured to generate the information based on the rotation count and transmit the information using a wireless transmitter, the circuit powered at least in part by the delivered electricity.

11. The method of claim 5 comprising:
selecting a power source used during outputting information.

12. A method for processing data received from a liquid measuring device, the method comprising:
receiving via a wireless link information derived from a rotation count of the liquid measuring device,
calculating data based on the information,
outputting the calculated data to a user display application.

13. The method of claim 12 wherein the information includes the rotation count.

14. The method of claim 12 comprising:
including additional predefined information with the output calculated data.

15. The method of claim 12 comprising:
outputting the calculated data to a local water authority.

16. The method of claim 12 comprising:
outputting the calculated data to a web based application.
